(19) United States
(12) Patent Application Publication
(10) Pub. No.: US 2026/0334384 A1
(43) Pub. Date: Oct. 29, 2026

(54) METHOD OF MANAGING INTERNAL ENVIRONMENT OF GREENHOUSE AND APPARATUS PERFORMING THE SAME

(71) Applicant: ELECTRONICS AND TELECOMMUNICATIONS RESEARCH INSTITUTE, Daejeon (KR)

(72) Inventors: HAK JONG SHIN, Daejeon (KR); Sangyeon LEE, Daejeon (KR); Dae Heon PARK, Daejeon (KR); Seng Kyoun JO, Daejeon (KR); Won Kyu CHOI, Daejeon (KR)

(21) Appl. No.: 19/544,284

(22) Filed: Feb. 19, 2026

(30) Foreign Application Priority Data
Apr. 23, 2025 (KR) 10-2025-0053218

(51) Int. Cl. A01G 9/26; A01G 9/14; A01G 9/24; G01W 1/00

(52) U.S. Cl. CPC A01G 9/26; A01G 9/14; A01G 9/246; G01W 1/00

(57) ABSTRACT

A method of managing an internal environment of a greenhouse is disclosed. The method includes acquiring weather data, acquiring a first temperature and humidity measured in the greenhouse, predicting an airflow speed of the greenhouse based on the weather data and the first temperature and humidity, predicting a second temperature and humidity of the greenhouse based on the weather data and the predicted airflow speed, and managing an operation of a heating and cooling facility of the greenhouse based on the predicted airflow speed and the second temperature and humidity.

### CROSS-REFERENCE TO RELATED APPLICATION

This application claims the benefit of Korean Patent Application No. 10-2025-0053218, filed on Apr. 23, 2025, in the Korean Intellectual Property Office, the entire disclosure of which is incorporated herein by reference for all purposes.

### BACKGROUND

### 1. Field of the Invention

The disclosure relates to a method of managing an internal environment of a greenhouse and an apparatus for performing the same.

### 2. Description of the Related Art

Recently, there is an increasing demand for precise control of an internal environment in various architectural spaces and greenhouses. In particular, environmental variables such as temperature, humidity, and airflow may directly affect various factors such as indoor work efficiency, energy consumption, and crop growth. For this reason, various technologies are being studied to predict environmental conditions of greenhouses and efficiently control heating and cooling facilities accordingly.

Typically, a method may be used to measure temperature and humidity in real time through a sensor network and control equipment based on the measured information. Additionally, a system that uses external weather data to perform a certain level of prediction has been proposed. However, these conventional technologies may have limitations in that they rely on simple physics-based models or have difficulty precisely reflecting interactions between various environmental variables.

The description has been possessed or acquired by the inventor(s) in the course of conceiving the present disclosure and is not necessarily an art publicly known before the present application is filed.

### SUMMARY

An embodiment may predict an airflow speed of a greenhouse based on data related to an external environment of the greenhouse and data related to an internal environment of the greenhouse.

An embodiment may predict a temperature and a humidity of a greenhouse based on data related to an external environment of the greenhouse and the predicted airflow speed of the greenhouse.

An embodiment may manage an operation of a heating and cooling facility of the greenhouse based on the predicted result.

However, technical aspects are not limited to the technical aspects described above, and other technical aspects may exist.

According to an aspect, there is provided a method of managing an internal environment of a greenhouse according to an embodiment, the method including acquiring weather data, acquiring a first temperature and humidity measured in the greenhouse, predicting an airflow speed of the greenhouse based on the weather data and the first temperature and humidity, predicting a second temperature and humidity of the greenhouse based on the weather data and the predicted airflow speed, and managing an operation of a heating and cooling facility of the greenhouse based on the predicted airflow speed and the second temperature and humidity.

The predicting of the airflow speed may be performed by a first model, and the predicting of the second temperature and humidity may be performed by a second model, wherein the first model may be a physics-informed neural network (PINN)-based neural network model, and the second model may be a building energy simulation-based model.

The method may further include updating the weather data, and re-predicting the airflow speed of the greenhouse by inputting the updated weather data and the second temperature and humidity to the first model.

The first model may be trained based on a value calculated by inputting the airflow speed predicted by the first model to Navier-Stokes equations.

The first model may be trained based on a difference value between a temperature and a humidity measured in a greenhouse having the same environment as the greenhouse and a temperature and humidity of a greenhouse having the same environment as the greenhouse according to the airflow speed predicted by the first model.

The predicting of the second temperature and humidity may include calculating an amount of heat due to conduction, convection, and radiation in a cladding of the greenhouse, based on the weather data, calculating a heat load of the heating and cooling facility of the greenhouse based on the weather data, calculating an amount of ventilation of air inside the greenhouse based on the weather data, calculating an evapotranspiration of crops within the greenhouse based on the predicted airflow speed, and predicting the second temperature and humidity based on the amount of heat, the heat load, the amount of ventilation, and the evapotranspiration.

The method may further include correcting parameters of the first model based on the first temperature and humidity of the greenhouse.

The weather data may include an external temperature, an external humidity, an amount of solar radiation, a wind direction, and a wind speed of the greenhouse.

According to an aspect, there is provided an electronic device for managing an internal environment of a greenhouse according to an embodiment, the electronic device including a processor and memory storing instructions that, when executed by the processor, cause the electronic device to acquire weather data, acquire a first temperature and humidity measured in the greenhouse, predict an airflow speed of the greenhouse based on the weather data, the first temperature and humidity, predict a second temperature and humidity of the greenhouse based on the weather data and the predicted airflow speed, and manage an operation of a heating and cooling facility of the greenhouse based on the predicted airflow speed and the second temperature and humidity.

The predicting of the airflow speed may be performed by a first model, and the predicting of the second temperature and humidity may be performed by a second model, wherein the first model may be a physics-informed neural network (PINN)-based neural network model, and the second model may be a building energy simulation-based model.

The instructions, when executed by the processor, may cause the electronic device to update the weather data, and re-predict the airflow speed of the greenhouse by inputting the updated weather data and the second temperature and humidity to the first model.

The first model may be trained based on a value calculated by inputting the airflow speed predicted by the first model to Navier-Stokes equations.

The first model may be trained based on a difference value between a temperature and humidity measured in a greenhouse having the same environment as the greenhouse and a temperature and a humidity of a greenhouse having the same environment as the greenhouse according to the airflow speed predicted by the first model.

The instructions, when executed by the processor, may cause the electronic device to calculate an amount of heat due to conduction, convection, and radiation in a cladding of the greenhouse, based on the weather data, calculate a heat load of the heating and cooling facility of the greenhouse based on the weather data, calculate an amount of ventilation of air inside the greenhouse based on the weather data, calculate an evapotranspiration of crops within the greenhouse based on the predicted airflow speed, and predict the second temperature and humidity based on the amount of heat, the heat load, the amount of ventilation, and the evapotranspiration.

The instructions, when executed by the processor, may cause the electronic device to correct parameters of the first model based on the first temperature and humidity measured in the greenhouse.

The weather data may include an external temperature, an external humidity, an amount of solar radiation, a wind direction, and a wind speed of the greenhouse.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a system for managing an internal environment of a greenhouse according to an embodiment;

FIG. 2 is a diagram illustrating a management device according to an embodiment;

FIG. 3 is a diagram illustrating a learning method of a first model according to an embodiment;

FIG. 4 is a diagram illustrating a first model according to an embodiment;

FIG. 5 is a diagram illustrating a second model according to an embodiment;

FIG. 6 is a diagram illustrating a method of predicting an airflow speed, and a temperature and humidity of a greenhouse, according to an embodiment;

FIG. 7 is a flowchart illustrating a method of managing an internal environment of a greenhouse according to an embodiment; and

FIG. 8 is a schematic block diagram of an electronic device according to an embodiment.

### DETAILED DESCRIPTION

The following structural or functional descriptions of embodiments described herein are merely intended for the purpose of describing the embodiments described herein and may be implemented in various forms. Here, the embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

When it is mentioned that one component is “connected” to or “accessed” by another component, it may be understood that the one component is directly connected to or accessed by another component or that still another component is interposed between the two components.

As used herein, the singular forms “a,” “an,” and “the” are intended to include the plural forms as well, unless the context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in the form of an application-specific integrated circuit (ASIC).

Hereinafter, embodiments will be described in detail with reference to the accompanying drawings. When describing the embodiments with reference to the accompanying drawings, like reference numerals refer to like components and a repeated description related thereto will be omitted.

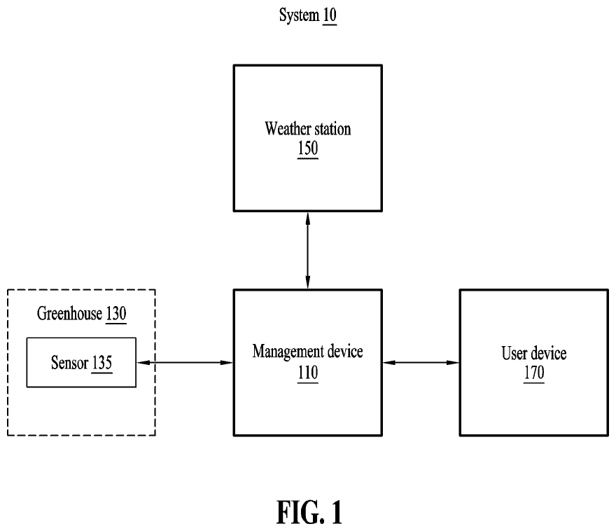

FIG. 1 is a diagram illustrating a system for managing an internal environment of a greenhouse according to an embodiment.

Referring to FIG. 1, according to an embodiment, a system 10 may include a management device 110, a greenhouse 130, a weather station 150, and a user device 170. The greenhouse 130 may include a plurality of sensors 135 to acquire information regarding an internal environment of a greenhouse. For example, the plurality of sensors 135 may be intended to measure a temperature and a humidity in the greenhouse 130.

The management device 110 may manage the internal environment of the greenhouse 130. The management device 110 may acquire information necessary to manage the internal environment from a plurality of organizations (or devices). For example, the management device 110 may acquire a temperature, a humidity, and the like of the greenhouse 130 from the sensor 135 installed in the greenhouse 130.

The management device 110 may acquire weather data related to the outside of the greenhouse 130 from the weather station 150. For example, the management device 110 may acquire information regarding an external temperature, a humidity, an amount of solar radiation, and the like of the greenhouse 130 from the weather station 150. The management device 110 may acquire the weather data related to the outside of the greenhouse 130 from the weather station 150 through a module provided by an application programming interface (API).

The management device 110 may predict an airflow speed of the greenhouse 130 based on the weather data and the temperature and humidity of the greenhouse 130 acquired from the sensor 135 installed in the greenhouse 130. The management device 110 may predict the temperature and humidity of the greenhouse 130 based on the weather data and the predicted airflow speed. The management device 110 may update the weather data. For example, the management device 110 may acquire weather data related to the outside of the greenhouse 130 that changes over time from the weather station 150. The management device 110 may predict the airflow speed of the greenhouse 130 based on the updated weather data and the predicted temperature and humidity. The management device 110 may transmit the predicted temperature and humidity and the predicted airflow speed to the user device 170.

The user device 170 may manage the internal environment of the greenhouse 130. For example, an administrator managing the internal environment of the greenhouse 130 may manage an operation of a heating and cooling facility of the greenhouse 130 through the user device 170. The user device 170 may acquire the predicted temperature and humidity and the predicted airflow speed of the greenhouse 130 from the management device 110. The administrator that manages the internal environment of the greenhouse 130 may manage the operation of the heating and cooling facility of the greenhouse 130 based on the predicted temperature and humidity and the predicted airflow speed of the greenhouse 130.

The greenhouse 130 may be a space for growing crops. A growth environment of crops in the greenhouse 130 may be affected by various dynamic environmental conditions such as the temperature and humidity of the greenhouse 130 and the airflow speed of the greenhouse 130. The airflow speed of the greenhouse 130 may be closely related to an evapotranspiration process of the crops. The airflow speed of the greenhouse 130 may act as an important variable in a thermal environment (e.g., temperature, humidity, amount of solar radiation, and the like of the greenhouse 130) of the greenhouse 130. Additionally, heat and moisture exchange during the evapotranspiration process of crops may directly affect changes in the temperature and humidity in the greenhouse 130. Evapotranspiration of crops may be a process by which water absorbed by roots of the crops is released into the air through leaves of the crops.

When the airflow speed is low, air resistance may increase as the air layer surrounding the crops in the greenhouse 130 thickens. The increased air resistance may reduce evapotranspiration from the crops. Accordingly, changes in the temperature and humidity of the greenhouse 130 may be limited. Conversely, when the airflow speed is high, the air resistance may be reduced as the air layer surrounding the crops in the greenhouse 130 becomes thinner. The reduced air resistance may increase evapotranspiration from the crops. Accordingly, changes in the temperature and humidity in the greenhouse 130 may increase. The airflow speed of the greenhouse 130 may directly affect changes in the temperature and humidity in the greenhouse 130. For example, when the airflow speed is high, the high airflow speed may accelerate heat transfer inside the greenhouse 130. Accordingly, the temperature inside the greenhouse 130 may quickly decrease, which may also affect the humidity of the greenhouse 130. That is, the airflow speed of the greenhouse 130 may act as a factor that determines the homogeneity of the overall environment of the greenhouse 130.

The temperature and humidity of the greenhouse 130 may also affect the airflow speed of the greenhouse 130. When the temperature of the greenhouse 130 is high or the humidity of the greenhouse 130 is low, air flow may occur naturally due to the difference in air density inside the greenhouse 130. Alternatively, the existing air flow in the greenhouse 130 may be strengthened. Due to the interaction between the airflow speed in the greenhouse 130 and the temperature and humidity in the greenhouse 130, it may be difficult to predict the internal environment of the greenhouse 130. When a model predicting the airflow speed of the greenhouse 130 and a model predicting the temperature and humidity of the greenhouse 130 operate independently, it may be difficult to predict the internal environment of the greenhouse 130.

The management device 110 may precisely analyze the interaction between the airflow speed of the greenhouse 130 and the temperature and humidity of the greenhouse 130. The management device 110 may accurately predict changes in the internal environment of the greenhouse 130. The management device 110 may accurately predict changes in the internal environment of the greenhouse 130 and efficiently control the temperature and humidity of the greenhouse 130. The management device 130 may accurately predict changes in the internal environment of the greenhouse 130, efficiently manage the operation of the heating and cooling facility of the greenhouse 130, and provide an optimal environment for the growth of crops within the greenhouse 130.

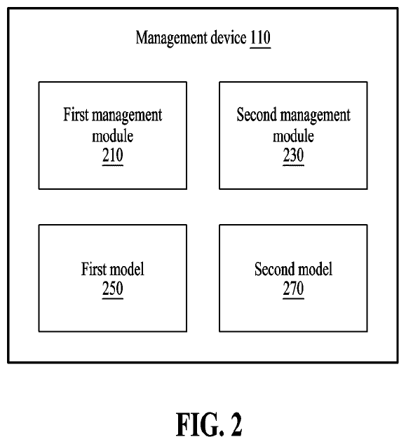

FIG. 2 is a diagram illustrating a management device according to an embodiment.

Referring to FIG. 2, according to an embodiment, the management device 110 may include a first management module 210, a second management module 230, a first model 250, and a second model 270.

The first management module 210 may manage weather data. The weather data may be acquired from the weather station 150. The first management module 210 may manage internal data of the greenhouse 130. The internal data of the greenhouse 130 may include a temperature and a humidity measured in the greenhouse 130. The internal data of the greenhouse 130 may be acquired from the sensor 135 of the greenhouse 130.

The second management module 230 may manage the first model 250 and the second model 270. The second management module 230 may acquire the temperature and humidity measured in the greenhouse 130 from the first management module 210. The second management module 230 may correct parameters of the first model 250 based on the temperature and humidity measured in the greenhouse 130. The second management module 230 may perform correction of the second model 270 based on the temperature and humidity measured in the greenhouse 130. For example, the second management module 230 may compare a temperature and a humidity predicted by the second model 270 with the temperature and humidity measured in the greenhouse 130. The second management module 230 may correct a calculation formula of the second model 270 based on the comparison result.

The first model 250 may predict an airflow speed of the greenhouse 130. The first model 250 may be a physics-informed neural network (PINN)-based neural network model.

The second model 270 may predict a temperature and a humidity of the greenhouse 130. The second model 270 may be a building energy simulation-based model. The second model 270 may calculate physical equations to predict the temperature and humidity of the greenhouse 130. The physical equations may include a heat calculation equation, a ventilation calculation equation, a heat load calculation equation, and an evapotranspiration calculation equation.

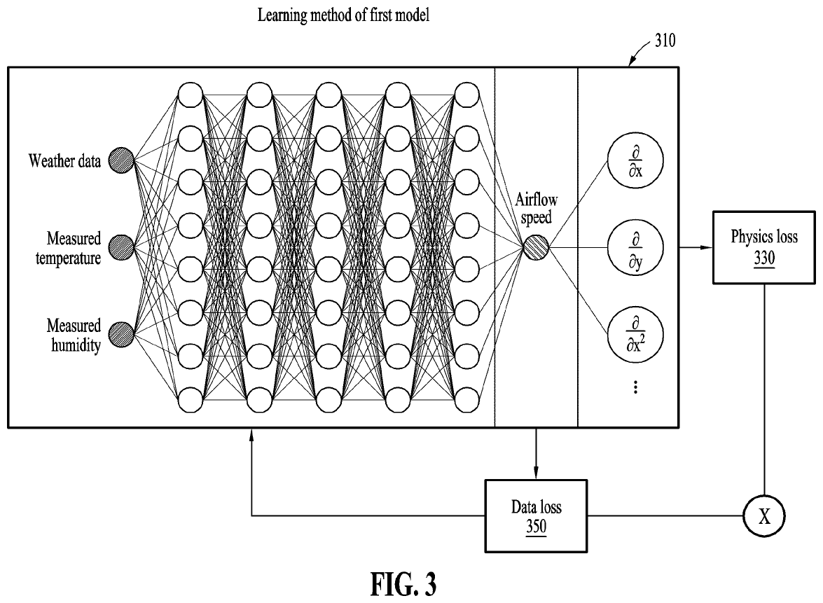

FIG. 3 is a diagram illustrating a learning method of a first model according to an embodiment.

Referring to FIG. 3, according to an embodiment, the first model 250 may be a PINN-based neural network model. The first model 250 may have a multi-layered neural network structure.

The first model 250 may be generated through machine learning. The machine learning may be performed, for example, on the management device 110 itself where the first model 250 is performed, or may be performed through a separate server. A learning algorithm may include, but is not limited to, supervised learning, unsupervised learning, semi-supervised learning, or reinforcement learning, for example. The first model 250 may include a plurality of artificial neural network layers. An artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of the above, but examples are not limited thereto. The first model 250 may additionally or alternatively include a software structure in addition to the hardware structure.

The first model 250 may use weather data, and the temperature and humidity measured in the greenhouse 130 (or a greenhouse having the same environment as the greenhouse 130) as input data. The first model 250 may output (or predict) the airflow speed of the greenhouse 130 based on input data.

The first model 250 may perform an operation 310 using Navier-Stokes equations during a learning process. In a learning process of the first model 250, the operation 310 using the Navier-Stokes equations may use the airflow speed output (or predicted) by the first model 250 as input data. During the learning process, the first model 250 may calculate a physics loss 330 based on the airflow speed predicted by the first model 250. The physics loss 330 may be calculated by using a differential value (e.g.,, and the like) of the airflow speed predicted by the first model 250. For example, the physics loss 330 may be a value calculated by inputting the airflow speed predicted by the first model 250 to the Navier-Stokes equations. The first model 250 may be trained based on the physics loss 330.

The first model 250 may calculate a data loss 350 during the learning process. The data loss 350 may be a difference value between the temperature and humidity measured in the greenhouse 130 (or a greenhouse having the same environment as the greenhouse 130) and a temperature and a humidity of the greenhouse 130 (or a greenhouse having the same environment as the greenhouse 130) according to the airflow speed predicted by the first model 250. The first model 250 may be trained based on the data loss 350.

The first model 250 may be trained based on the product of the physics loss 330 and the data loss 350. Accordingly, the first model 250 may provide a prediction result by reflecting physical laws and measured data.

The airflow speed of the greenhouse 130 may act as an important variable that determines the internal environment of the greenhouse 130. However, there may be technical limitations in actually measuring the airflow speed in the greenhouse 130. Additionally, measuring the airflow speed in the greenhouse 130 may require a high cost. Existing airflow analysis techniques using computational fluid dynamics (CFD) may also require high computational costs. Accordingly, it may be difficult to measure the airflow speed of the greenhouse 130 in real time using existing technology. The first model 250 may predict the airflow speed of the greenhouse 130 in real time through the PINN-based neural network model using the Navier-Stokes equations.

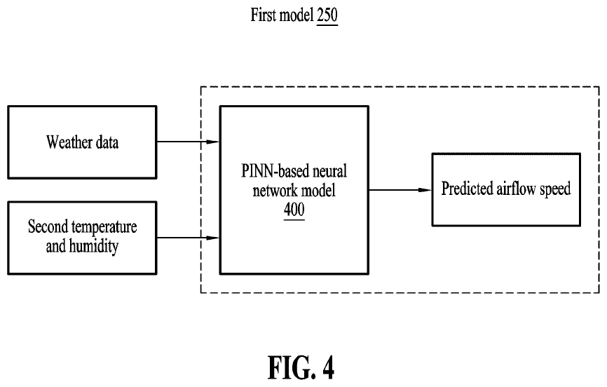

FIG. 4 is a diagram illustrating a first model according to an embodiment.

Referring to FIG. 4, according to an embodiment, the first model 250 may be a PINN-based neural network model 400.

The first model 250 may predict an airflow speed of the greenhouse 130. The first model 250 may be the first model 250 learned through the learning method described with reference to FIG. 3.

The first model 250 may acquire weather data and a second temperature and humidity as inputs. The second temperature and humidity may be a temperature and humidity of the greenhouse 130 predicted by a second model (e.g., the second model 270 of FIG. 2).

The first model 250 may predict the airflow speed of the greenhouse 130 based on the weather data and the second temperature and humidity.

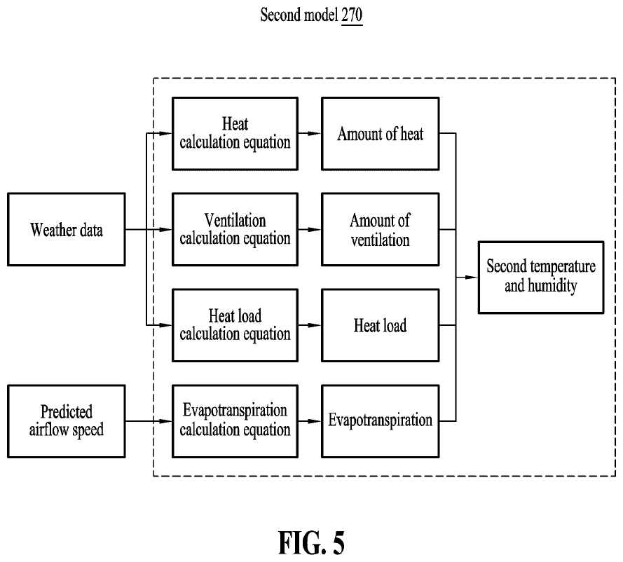

FIG. 5 is a diagram illustrating a second model according to an embodiment.

Referring to FIG. 5, according to an embodiment, the second model 270 may be a building energy simulation-based model. The second model 270 may be modeled and analyzed using simulation tools such as EnergyPlus, Transient System Simulation Tool (TRNSYS), and the like. The second model 270 may calculate physical equations.

The second model 270 may predict a temperature and humidity of the greenhouse 130. The temperature and humidity of the greenhouse 130 may be the second temperature and humidity. The second temperature and humidity may be different from a temperature and humidity measured in the greenhouse 130. The second temperature and humidity may be a temperature and humidity of the greenhouse 130 predicted by the second model 270. The first temperature and humidity may be a temperature and humidity measured in the greenhouse 130. The first temperature and humidity may be a temperature and humidity measured by the sensor 135 installed in the greenhouse 130.

The second model 270 may acquire weather data and an airflow speed predicted by the first model 250 as inputs. The weather data may be acquired from a weather station (e.g., the weather station 150 of FIG. 1). The weather data may include an external temperature, an external humidity, an amount of solar radiation, a wind direction, and a wind speed of the greenhouse 130.

The second model 270 may calculate an amount of heat due to conduction, convection, and radiation in a cladding of the greenhouse 130, based on the weather data. For example, the second model 270 may calculate the amount of heat due to conduction, convection, and radiation in the cladding of the greenhouse 130 by substituting values of the weather data into a heat calculation equation. The second model 270 may calculate the amount of heat in the greenhouse 130 based on an interaction between thermal properties of the cladding and the weather data through the heat calculation equation. Specifically, the second model 270 may calculate the amount of heat flowing into or out of the greenhouse 130.

The second model 270 may calculate a heat load of a heating and cooling facility of the greenhouse 130 based on the weather data. For example, the second model 270 may calculate the heat load of the heating and cooling facility of the greenhouse 130 by substituting values of the weather data into a heat load calculation equation. The heat load of the heating and cooling facility of the greenhouse 130 may directly affect the energy consumption of the greenhouse 130. By calculating the heat load of the heating and cooling facility of the greenhouse 130, the second model 270 may support optimization of the temperature and energy efficiency of the greenhouse 130.

The second model 270 may calculate an amount of ventilation of air inside the greenhouse 130 based on the weather data. For example, the second model 270 may calculate the amount of ventilation of the air inside the greenhouse 130 by substituting values of the weather data into a ventilation amount calculation equation. The amount of ventilation may be an important factor affecting the quality and the thermal stability of the air inside the greenhouse 130. The second model 270 may predict an amount of exchange between the internal and external air of the greenhouse 130 by calculating the amount of ventilation.

The second model 270 may calculate an evapotranspiration of crops in the greenhouse 130 based on the airflow speed predicted by the first model 250. For example, the second model 270 may calculate the amount of ventilation of the air inside the greenhouse 130 by substituting the airflow speed predicted by the first model 250 into an evapotranspiration calculation equation. The airflow speed may change an air flow around crops. Accordingly, the airflow speed may directly affect the evapotranspiration of crops. By calculating the evapotranspiration of crops, a humidity change inside the greenhouse 130 may be predicted.

The second model 270 may predict the temperature and humidity of the greenhouse 130 based on the weather data and the airflow speed predicted by the first model 250. By using prediction results of the second model 270, the internal environment of the greenhouse 130 may be precisely managed. In addition, by using the prediction results of the second model 270, the internal environment of the greenhouse 130 may be managed efficiently.

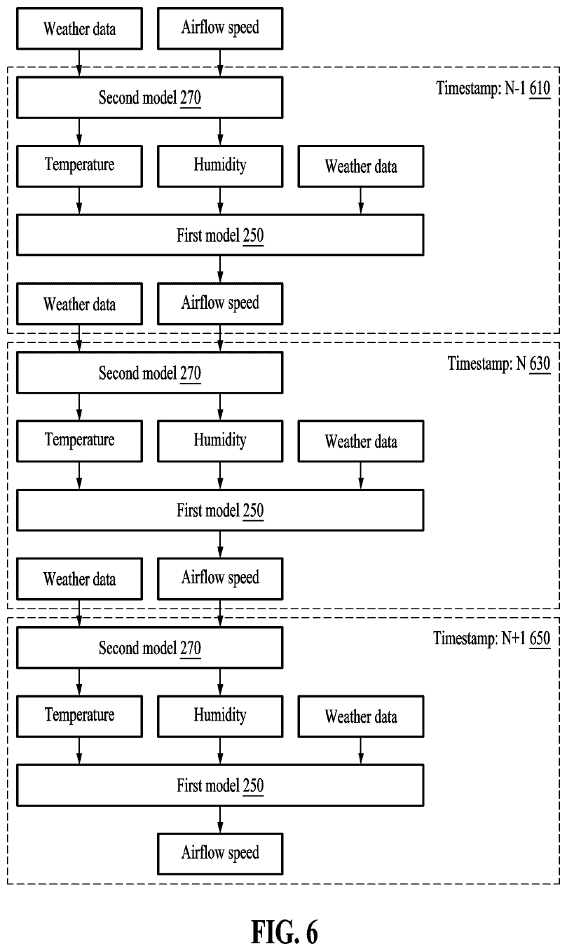

FIG. 6 is a diagram illustrating a method of predicting an airflow speed and, a temperature and humidity of a greenhouse, according to an embodiment.

Referring to FIG. 6, according to an embodiment, the first model 250 and the second model 270 may interact to predict an airflow speed, and a temperature and humidity of the greenhouse 130.

The second model 270 may acquire weather data and an airflow speed predicted by the first model 250 as input data. The second model 270 may predict a temperature and humidity of the greenhouse 130 based on the weather data and the airflow speed predicted by the first model 250. The management device 110 may acquire, from the weather station 150, weather data that changes over time. The management device 110 may update weather data based on the acquired weather data. The first model 250 may predict an airflow speed of the greenhouse 130 based on the updated weather data and the temperature and humidity predicted by the second model 270. As time passes, the management device 110 may re-acquire changed weather data from the weather station 150. The management device 110 may update weather data based on the acquired weather data.

Timestamps N−1 610, N 630, and N+1 650 may distinguish an operation of the management device 110 over time. Operations performed by the management device 110 at timestamps N−1 610, N 630, and N+1 650 may be substantially the same.

The first model 250 and the second model 270 of the management device 110 may be structurally connected and designed to predict changes in the internal environment of the greenhouse 130 in real time. The internal environment of the greenhouse 130 may be precisely analyzed and managed through prediction results of the first model 250 and the second model 270 of the management device 110.

By precisely predicting the airflow speed of the greenhouse 130 and the evapotranspiration process of crops in the greenhouse through the first model 250 and the second model 270 of the management device 110, a heat exchange environment around the crops may be improved. In addition, the management device 110 may maintain an optimal temperature and humidity of the greenhouse 130. The management device 110 may contribute to increasing the productivity of the greenhouse 130 by maintaining consistency in a growth environment of the crops within the greenhouse 130. By managing the internal environment of the greenhouse 130 through the prediction results of the first model 250 and the second model 270 of the management device 110, energy saving of the greenhouse 130 may be supported. Sustainable agriculture may be achieved through energy resource management of the greenhouse 130 via the management device 110.

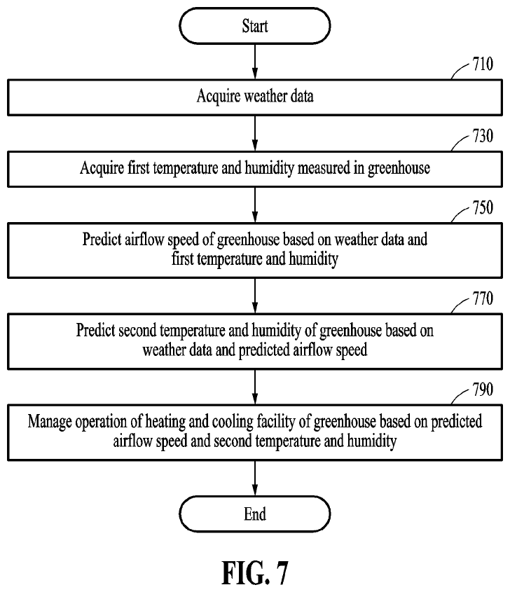

FIG. 7 is a flowchart illustrating a method of managing an internal environment of a greenhouse according to an embodiment.

Referring to FIG. 7, according to an embodiment, the management device 110 described with reference to FIGS. 1 to 6 may perform an operation for managing an internal environment of the greenhouse 130.

In operation 710, the management device 110 may acquire weather data from the weather station 150.

In operation 730, the management device 110 may acquire a first temperature and humidity measured in the greenhouse 130.

In operation 750, the management device 110 may predict an airflow speed of the greenhouse 130 based on the weather data and the first temperature and humidity.

In operation 770, the management device 110 may predict a second temperature and humidity of the greenhouse 130 based on the weather data and the predicted airflow speed.

In operation 790, the management device 110 may manage an operation of a heating and cooling facility of the greenhouse 130 based on the predicted airflow speed and the second temperature and humidity.

Operations 710 to 770 may be performed sequentially but not necessarily. For example, two or more operations may be performed in parallel. Operations 710 to 770 may be substantially the same as the method of managing the internal environment of the greenhouse according to an embodiment performed by the management device 110 described with reference to FIGS. 1 to 6.

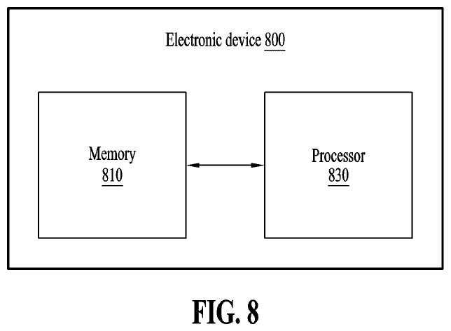

FIG. 8 is a schematic block diagram of an electronic device according to an embodiment.

Referring to FIG. 8, according to an embodiment, an electronic device 800 may include memory 810 and a processor 830.

The memory 810 may store instructions (or a program) executable by the processor 830. For example, the instructions may include instructions for executing operations of the processor 830 and/or operations of each component of the processor 830.

The memory 810 may include one or more computer-readable storage media. The memory 810 may include non-volatile storage devices (e.g., magnetic hard disc, optical disc, floppy disc, flash memory, erasable programmable read-only memory (EPROM), and electrically erasable programmable read-only memory (EEPROM).

The memory 810 may be non-transitory media. The term “non-transitory” may indicate that a storage medium is not implemented as a carrier wave or propagated signal. However, the term “non-transitory” should not be interpreted to mean that the memory 810 is immovable.

The processor 830 may process data stored in the memory 810. The processor 830 may execute computer-readable code (e.g., software) stored in the memory 810 and instructions triggered by the processor 830.

The processor 830 may be a data processing device implemented as hardware having a circuit having a physical structure for executing desired operations. For example, the desired operations may include code or instructions included in a program.

For example, the data processing device implemented as hardware may include a microprocessor, a central processing unit (CPU), a processor core, a multi-core processor, a multiprocessor, an ASIC, or a field programmable gate array (FPGA).

The processor 830 may cause the electronic device 800 to perform one or more operations by executing code and/or instructions stored in the memory 810. The operations performed by the electronic device 800 may be substantially the same as the operations performed by the management device 110 described with reference to FIGS. 1 to 7. Accordingly, any repeated descriptions related thereto will be omitted.

The components described in the embodiments may be implemented by hardware components including, for example, at least one digital signal processor (DSP), a processor, a controller, an ASIC, a programmable logic element, such as an FPGA, other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using hardware components, software components, or a combination thereof. A processing device may be implemented using one or more general-purpose or special purpose computers, such as, for example, a processor, a controller, an arithmetic logic unit (ALU), a DSP, a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer readable recording mediums.

The method according to the above-described embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter.

The described hardware devices may be configured to act as one or more software modules in order to perform the operations of the above-described embodiments, or vice versa.

While this disclosure includes embodiments, it will be apparent to one of ordinary skill in the art that various changes in form and details may be made in these embodiments without departing from the spirit and scope of the claims and their equivalents. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of managing an internal environment of a greenhouse, the method comprising:
acquiring weather data;
acquiring a first temperature and humidity measured in the greenhouse;
predicting an airflow speed of the greenhouse based on the weather data and the first temperature and humidity;
predicting a second temperature and humidity of the greenhouse based on the weather data and the predicted airflow speed; and
managing an operation of a heating and cooling facility of the greenhouse based on the predicted airflow speed and the second temperature and humidity.

2. The method of claim 1, wherein
predicting of the airflow speed is performed by a first model, and
predicting of the second temperature and humidity is performed by a second model,
wherein the first model is a physics-informed neural network (PINN)-based neural network model, and the second model is a building energy simulation-based model.

3. The method of claim 2, further comprising:
updating the weather data; and
re-predicting the airflow speed of the greenhouse by inputting the updated weather data and the second temperature and humidity to the first model.

4. The method of claim 2, wherein
the first model is trained based on a value calculated by inputting the airflow speed predicted by the first model to Navier-Stokes equations.

5. The method of claim 2, wherein
the first model is trained based on a difference value between a temperature and humidity measured in a greenhouse having the same environment as the greenhouse and a temperature and humidity of a greenhouse having the same environment as the greenhouse according to the airflow speed predicted by the first model.

6. The method of claim 1, wherein
predicting of the second temperature and humidity comprises:
calculating an amount of heat due to conduction, convection, and radiation in a cladding of the greenhouse, based on the weather data;
calculating a heat load of the heating and cooling facility of the greenhouse based on the weather data;
calculating an amount of ventilation of air inside the greenhouse based on the weather data;
calculating an evapotranspiration of crops within the greenhouse based on the predicted airflow speed; and
predicting the second temperature and humidity based on the amount of heat, the heat load, the amount of ventilation, and the evapotranspiration.

7. The method of claim 2, further comprising:
correcting parameters of the first model based on the first temperature and humidity of the greenhouse.

8. The method of claim 1, wherein
the weather data comprises an external temperature, an external humidity, an amount of solar radiation, a wind direction, and a wind speed of the greenhouse.

9. A non-transitory computer-readable storage medium storing instructions that, when executed by a processor, cause the processor to perform the method of claim 1.

10. An electronic device for managing an internal environment of a greenhouse, the electronic device comprising:
a processor; and
memory storing instructions that, when executed by the processor, cause the electronic device to:
acquire weather data,
acquire a first temperature and humidity measured in the greenhouse,
predict an airflow speed of the greenhouse based on the weather data, the first temperature and humidity,
predict a second temperature and humidity of the greenhouse based on the weather data and the predicted airflow speed, and
manage an operation of a heating and cooling facility of the greenhouse based on the predicted airflow speed and the second temperature and humidity.

11. The electronic device of claim 10, wherein
predicting of the airflow speed is performed by a first model, and
predicting of the second temperature and humidity is performed by a second model,
wherein the first model is a physics-informed neural network (PINN)-based neural network model, and the second model is a building energy simulation-based model.

12. The electronic device of claim 11, wherein the instructions, when executed by the processor, cause the electronic device to:
update the weather data, and
re-predict the airflow speed of the greenhouse by inputting the updated weather data and the second temperature and humidity to the first model.

13. The electronic device of claim 11, wherein
the first model is trained based on a value calculated by inputting the airflow speed predicted by the first model to Navier-Stokes equations.

14. The electronic device of claim 11, wherein
the first model is trained based on a difference value between a temperature and humidity measured in a greenhouse having the same environment as the greenhouse and a temperature and humidity of a greenhouse having the same environment as the greenhouse according to the airflow speed predicted by the first model.

15. The electronic device of claim 10, wherein the instructions, when executed by the processor, cause the electronic device to:
calculate an amount of heat due to conduction, convection, and radiation in a cladding of the greenhouse, based on the weather data,
calculate a heat load of the heating and cooling facility of the greenhouse based on the weather data,
calculate an amount of ventilation of air inside the greenhouse based on the weather data,
calculate an evapotranspiration of crops within the greenhouse based on the predicted airflow speed, and
predict the second temperature and humidity based on the amount of heat, the heat load, the amount of ventilation, and the evapotranspiration.

16. The electronic device of claim 11, wherein the instructions, when executed by the processor, cause the electronic device to:
correct parameters of the first model based on the first temperature and humidity measured in the greenhouse.

17. The electronic device of claim 10, wherein
the weather data comprises an external temperature, an external humidity, an amount of solar radiation, a wind direction, and a wind speed of the greenhouse.
